(19) United States
(12) Patent Application Publication
(10) Pub. No.: US 2011/0279110 A1
(43) Pub. Date: Nov. 17, 2011

(54) Electronic probe housing for steam turbine

(76) Inventors: Timothy A. Pieszchala, Seabrook, TX (US); James Leon Jacoby, JR., Sugarland, TX (US); James Wallace Greene, Pasadena, TX (US)

(21) Appl. No.: 12/800,213

(22) Filed: May 11, 2010

(51) Int. Cl. G01B 7/30

(52) U.S. Cl. 324/207.25

(57) ABSTRACT

An inner chamber in a housing surrounding a first end of a drive shaft upon which the turbine blades are mounted, a gear ring within the inner chamber fixedly attached to the first end of the drive shaft, the gear ring having a plurality of spaced, ferrite extensions, two magnetic pickup sensors mounted within the inner chamber of the housing in near proximity to the spaced extensions providing indicia of rotating speed as the gear ring revolves with the drive shaft while the magnetic pickup devices remain stationary within the housing, and providing further that during operation, the electronic probe housing automatically sends electric signals to an electronic governor which causes the RPM of the steam turbine to increase, decrease or remain constant.

### BACKGROUND OF THE INVENTION

Steam turbines have been well known in the art for many years, with the modern steam turbine having apparently been invented by the Englishman Sir Charles Parsons in 1884, an invention which was later scaled-up by the American George Westinghouse. The classic steam turbine, in perhaps its most simplistic form, is illustrated as prior art in FIG. 1A, showing the entry of steam to cause the turbine blades to spin, which in turn causes a generator to spin, thus spinning the generator to produce electricity. The steam enters the apparatus of FIG. 1A through one or more valves, it being known that the rotational speed of the turbine is controlled by the varying of the number of valves, and/or by positioning of such valves and/or by changing the volumetric opening through such one or more such valves.

It is also well-known in this art to use a governor with the valve system discussed above to control the rotational speed of the turbine by controlling the steam flow.

It is also known in this art to use microprocessor based control systems marketed by the Woodward Governor Company, located at 1000 East Drake Road, Fort Collins, Colo. 80525, designed to function with speed monitors available from other sources.

Moreover, it is known in the prior art to measure the rotational speed, i.e., the timed number of revolutions of the turbine shaft, to control the hydraulic actuators involved with the controlled movement of the valves and thus control of the steam turbine. These types of known systems are described in detail in U.S. Pat. No. 4,461,152 to Yashuhiro Tennichi and Naganobu Honda, and in U.S. Pat. No. 4,658,590 to Toshihiko Higashi and Yasuhiro Tennicho.

### BRIEF DESCRIPTION OF DRAWINGS

FIG. 1A is a pictorial, simplistic view of a steam turbine well known in the prior art;

FIGS. 1B and 1C are block diagrams of a steam turbine system using an electronic probe housing in combination with a governor, a steam governoring valve, a steam turbine and a rotatable load according to the invention;

FIG. 1D is a pictorial view of a worm and worm gear as used in FIG. 1C.

FIG. 2 is a pictorial view of the electronic probe housing according to the invention;

FIG. 3 is a pictorial view of the electronic probe housing according to the invention;

FIG. 4 is a pictorial view of the electronic probe housing according to the invention;

FIG. 5A is a top plan view of the end cap used with the electronic probe housing according to the invention;

FIG. 5B is a cut-away side view of the end cup illustrated in FIG. 5A according to the invention;

FIG. 6A is a top plan view of the back plate of the electronic probe housing according to the invention;

FIG. 6B is a cut-away view of the back plate illustrated in FIG. 6A;

FIG. 7 is a pictorial side view of a short section of drive shaft used inside the electronic probe housing according to the invention;

FIG. 8A is a top plan view of a gear ring according to the invention;

FIG. 8 B is a cut-away side view of the gear ring illustrated in FIG. 8A according to the invention;

FIG. 9A is a pictorial view of the sub-housing used with the electronic probe housing of FIGS. 2A, 3A and 4A according to the invention;

FIG. 9B is a top plan view of the sub-housing illustrated in FIG. 9A;

FIG. 10 is a pictorial view of the electronic probe housing prior to being assembled according to the invention; and

FIG. 11 is a pictorial view of two of the magnetic sensor probes used in accordance with the invention.

### DETAILED DESCRIPTION OF PREFERRED EMBODIMENT OF INVENTION

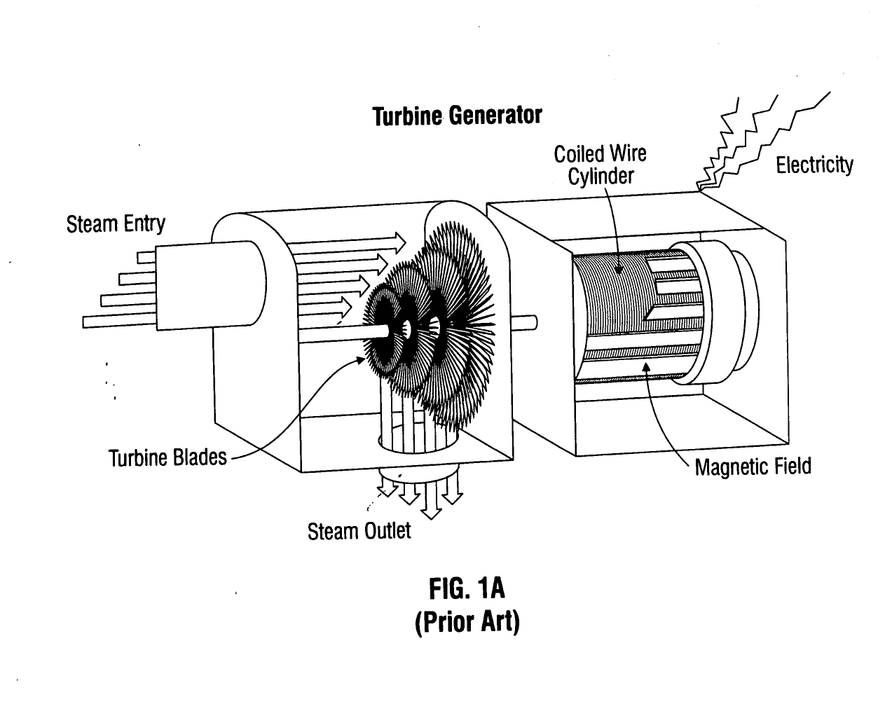

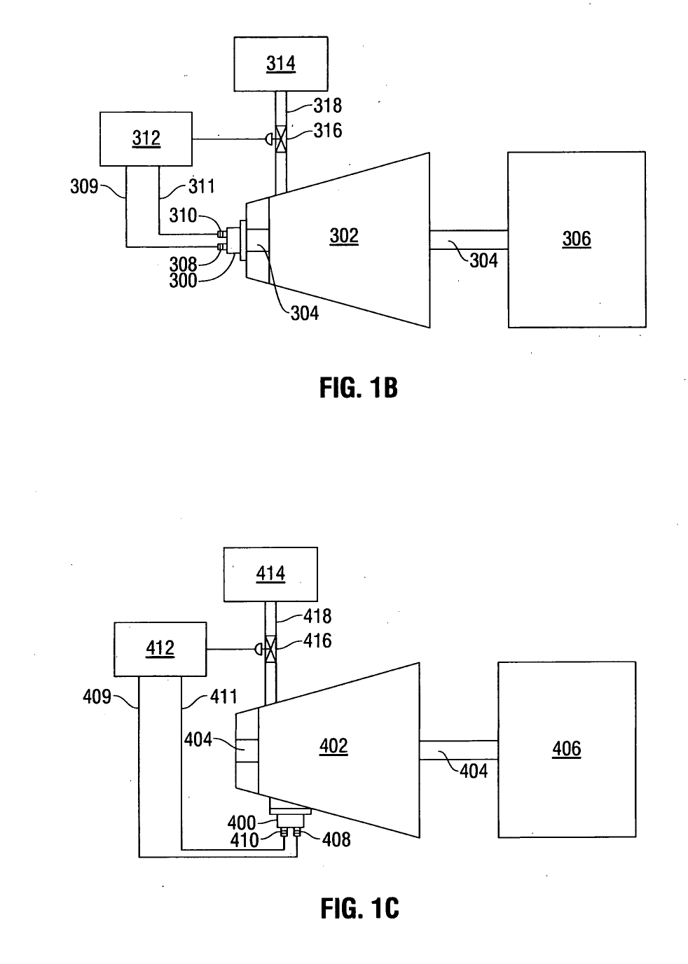

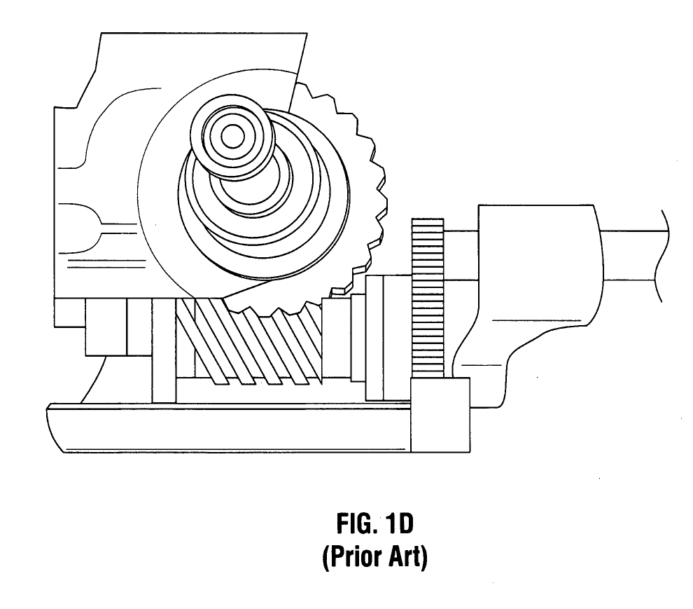

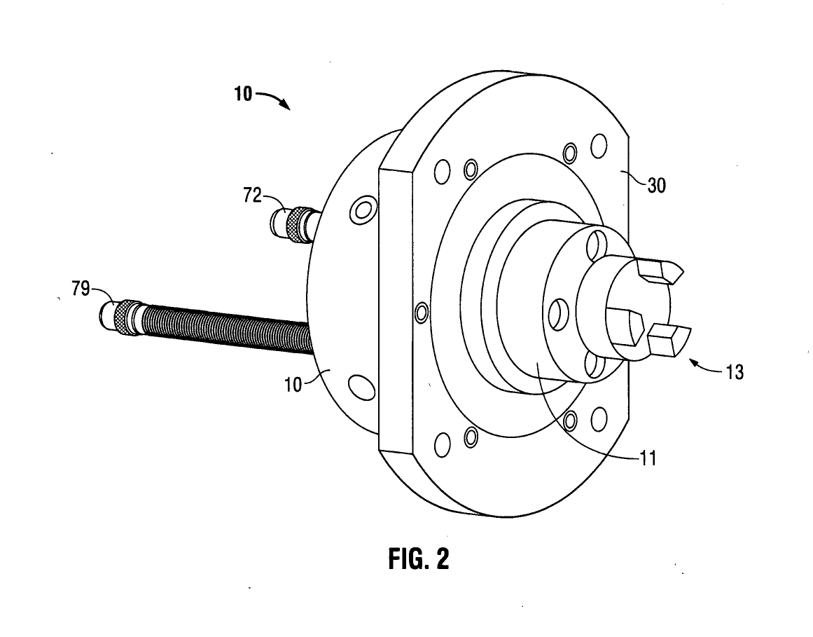

FIG. 1A illustrates a typical steam turbine generator, well-known in the prior art, in which steam enters the turbine to thus cause the turbine blades, mounted on a rotatable shaft, to spin a generator to produce electricity. Such steam turbines are also used to drive other rotatable equipment such as motors, compressors, pumps and the like. Such prior art steam turbines typically use positionable valves (not illustrated in FIG. 1A) to control the steam impacting the turbine blades to thus control the speed of rotation of the shaft.

It is known in the prior art to measure the pressure of the steam as the steam exits the enclosure around the turbine blades, since such steam pressure differential, up or down, is an indication of the changes in the speed of rotation of the drive shaft. For example, if the steam pressure from the exit port decreases, the one or more steam valves can be manipulated manually to thereby increase the speed of shaft rotation up to a desired level.

It is also known in this art to locate an electronic sensor on or near the drive shaft, with a visual sensor, and when the sensor provides a visual indication of speed change to a technician or engineer, such technician or engineer can then manually adjust the steam valve or valves to thereby adjust the speed of rotation of the drive shaft.

FIG. 1B illustrates in block diagram the electronic probe housing 300 according to the present invention in use with a steam turbine 302 having a rotatable drive shaft 304 between the housing 300 and the turbine 302, and between the turbine 302 and the load 306, which may be any rotatable equipment, such as a generator, a pump, a compressor or the like.

FIG. 1B also illustrates a pair of magnetic pickup sensors 308 and 310 coming out of the probe housing 300, and having electrical lines 309 and 311 leading into the electronic governor 312. A source of pressurized steam 314 is connected through one or more valves 316 in steam pipe 318 into the steam turbine 302 to drive the turbine blades therein.

FIG. 1C illustrates in block diagram the electronic probe housing 400 according to the present invention in use with a steam turbine 402 having a rotatable drive shaft 404 between the housing 400 and the turbine 402, and between the turbine 402 and the load 406, which may be any rotatable equipment, such as a generator, a pump, a compressor or the like.

FIG. 1C also illustrates a pair of magnetic pickup sensors 408 and 410 coming out of the probe housing 400, and having electrical lines 409 and 411 leading into the electronic governor 41. A source of pressurized steam 414 is connected through one or more valves 416 in steam pipe 418 into the steam turbine 402 to drive the turbine blades therein.

The only difference between the embodiments of FIGS. 1B and 1C is the use of a conventional worm and a worm gear, illustrated in FIG. 1D within the steam turbine 402 which causes the drive shaft 404 to exit the lower side of the steam turbine 402 instead of at the back side of the steam turbine. As is well known, the worm gear drive has its drive axes at 90° to each other, and is typically used to decrease speed and to increase torque.

FIGS. 2, 3 and 4 pictorially illustrate an electric probe housing 10 according to the invention, the individual components of which are illustrated and described hereinafter in greater detail.

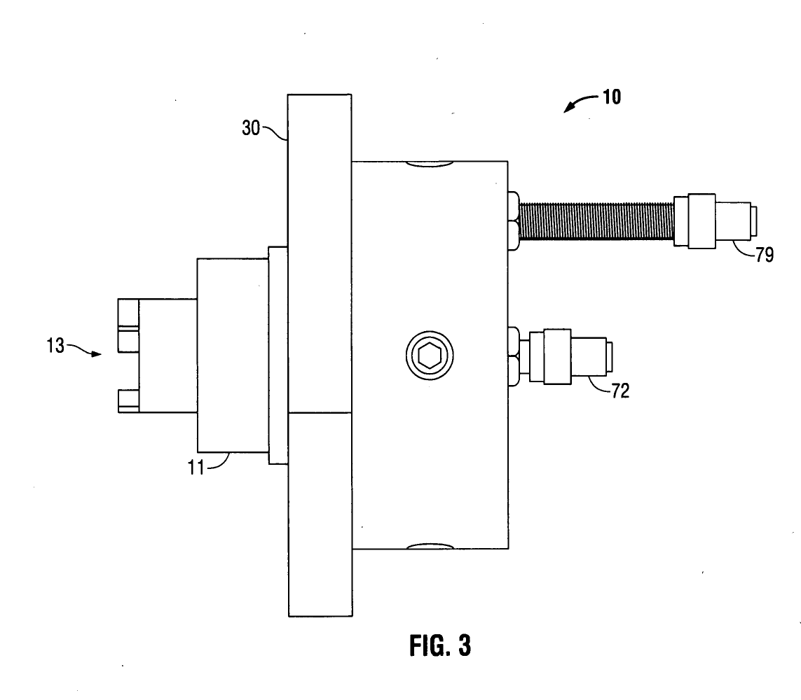

FIGS. 2 and 3 illustrate in two views the completely assembled electronic probe according to the invention, including the end cap 11, the back plate 30, the housing 10 and the probes 72 and 79. The known coupling 13 is commercially available from Lovejoy, Inc., preferable their Model “L”, located at 2655 Wisconsin Avenue, Downers Grove, Ill. 60515. This coupling is used to connect the second end of the small drive shaft 32 to the main drive shaft.

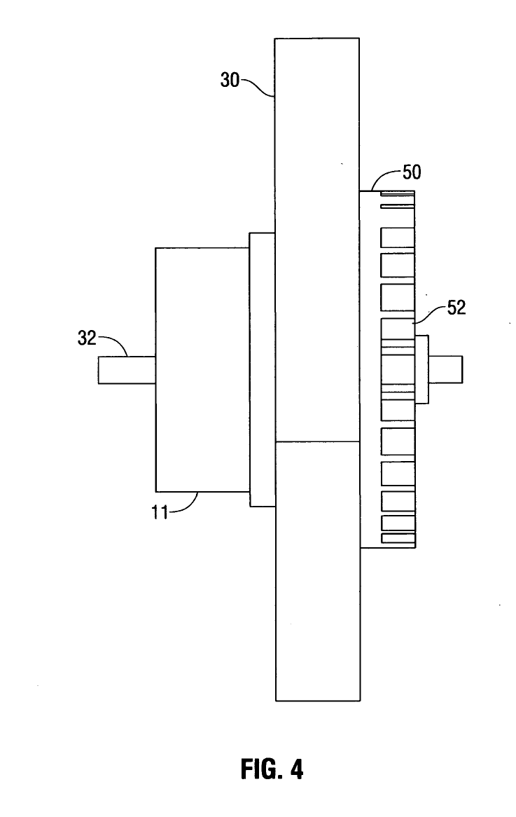

FIG. 4 illustrates the partial assembly of the electronic probe according to the invention, illustrating the gear ring 50 and its extensions 52, but not yet showing the remainder of the housing 10 which will surround and enclose the gear ring 50 as illustrated in FIGS. 2 and 3, and does not yet show the fixture 12 as is illustrated in FIGS. 2 and 3.

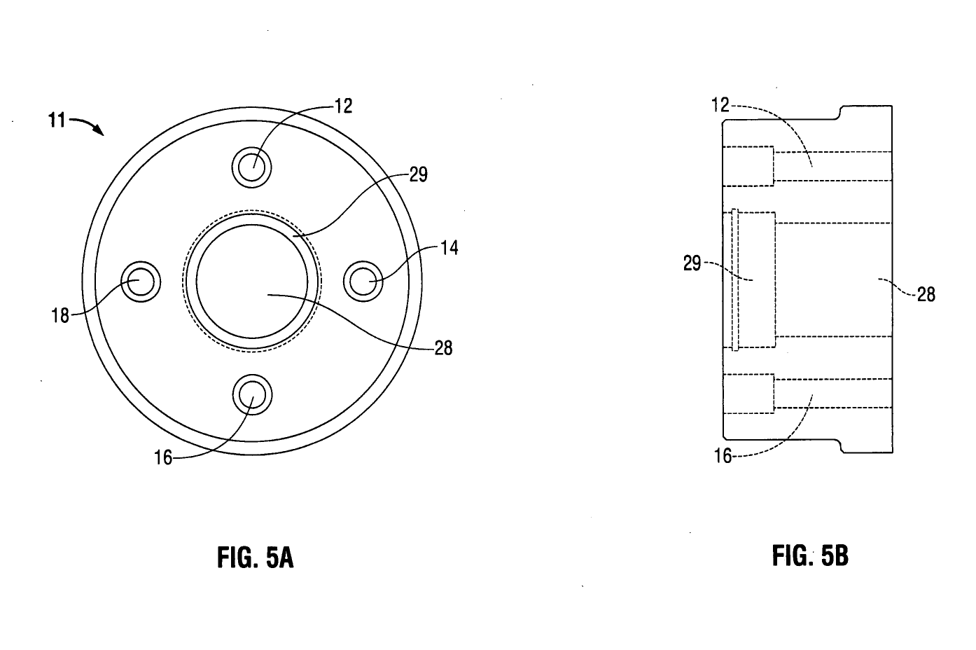

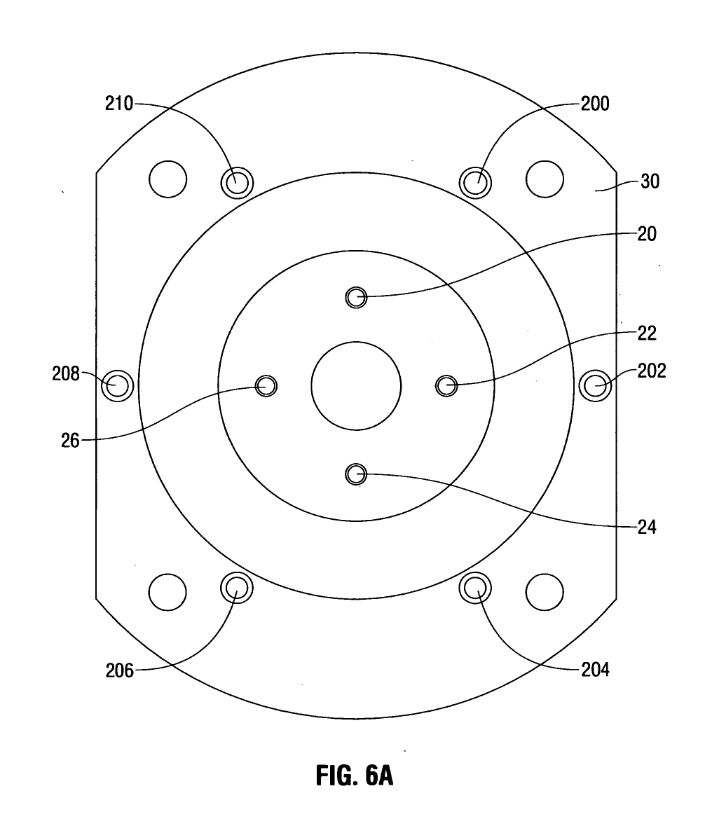

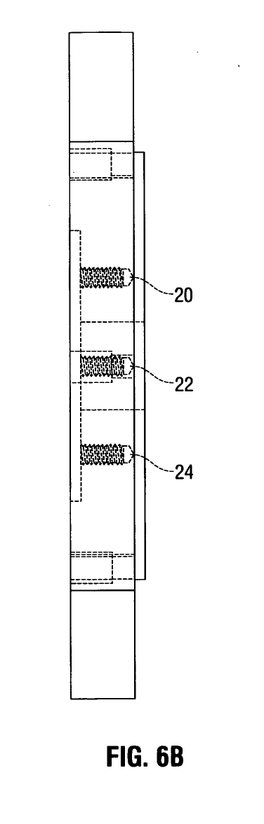

FIG. 5A illustrates a top plan view of the end bearing cylindrical cap 11 associated with the housing 10, and having four mounting thru-holes 12, 13, 14 and 15 to allow the cap 11 to be threadedly connected to the four holes 20, 22, 24 and 26 in the back plate 30 illustrated in a top plan view in FIG. 6A. The housing 10 also has thru-hole 28 and bearing 29 through which a drive shaft 32 extends. FIG. 5B illustrates a cut-away side view of the end cap 10.

Referring further to FIGS. 6A and 6B, the back plate 30 is essentially cylindrical in shape other than for having two of its opposing sides parallel. The plate 30 has a central thru-hole 34 mating with the thru-hole 28 of the cap 10 shown in FIG. 5A. The thru-hole 34 also has a bearing therein, if desired, to facilitate rotation of the shaft 32.

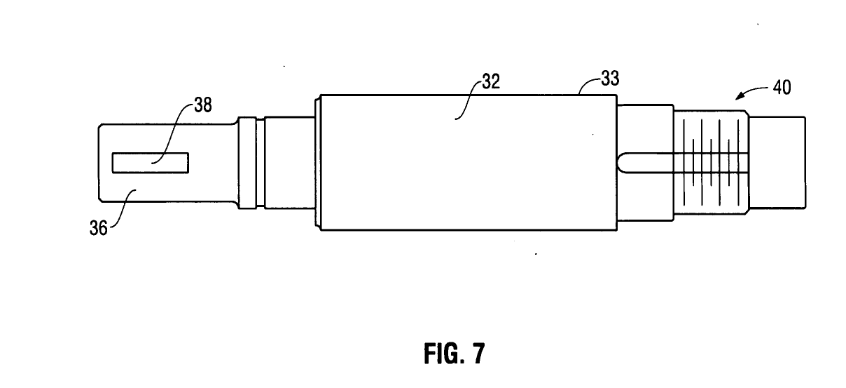

FIG. 7 illustrates a short length of rotatable drive shaft 32 having a central raised surface long enough to snugly fit within the thru-holes 28 and 34 and the bearings therein to avoid vibration. The end 36 of drive shaft 32 preferably has a Woodruff key 38 for attachment to a key seat, all as is well-known in the art for forming a keyed joint between a pair of objects. The other end 40 of the drive shaft 32 has a bearing nut 42.

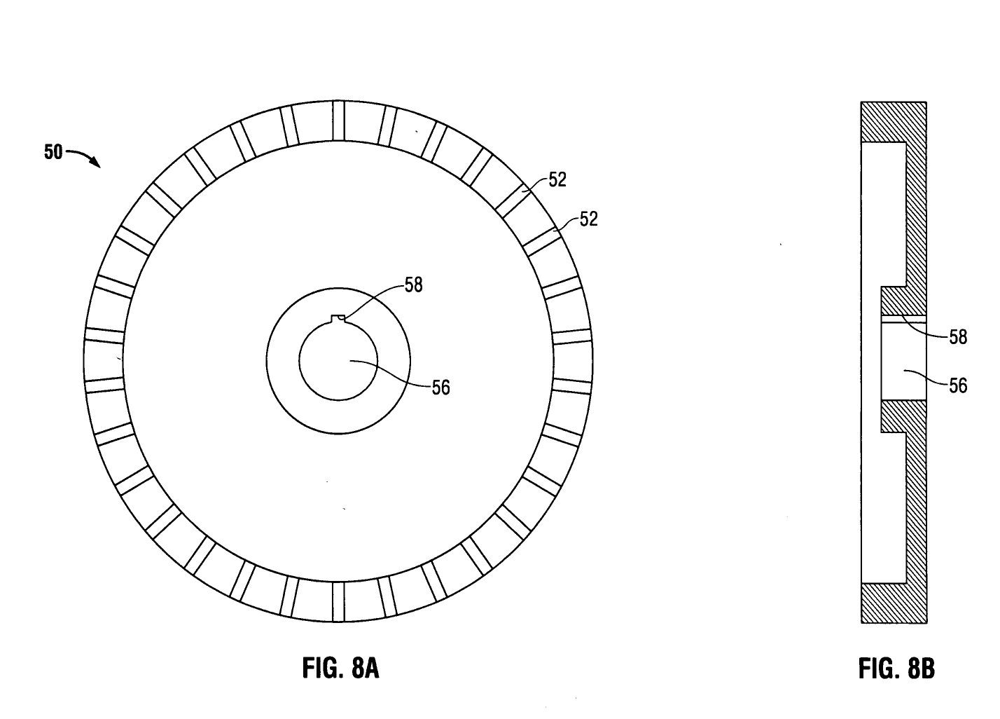

FIG. 8A illustrates a top plan view of a gear ring 50 preferably having thirty extended positions 52, the number thirty for such extended portions being preferable only because alternating current typically is 60 Hz, thus making the calculations and calibrations easier to compute. Some geographic regions are known to use 50 Hz, so it may be appropriate to use twenty five extensions instead of thirty.

The gear ring 50 also has a central raised, cylindrical portion 54 having a thru-hole 56 and a key seat 58 to accommodate a key on the shaft 32 to prevent relative rotation between the gear ring 50 and the shaft 32.

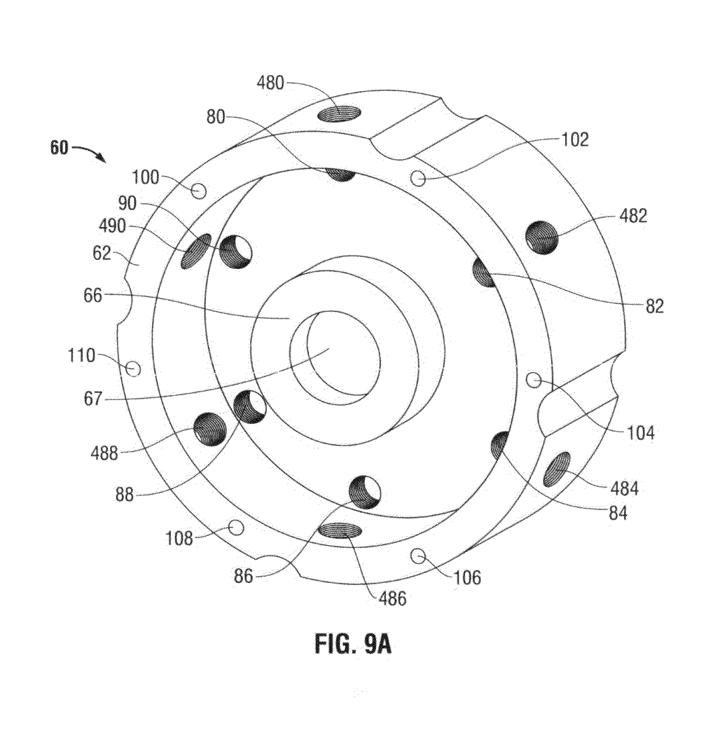

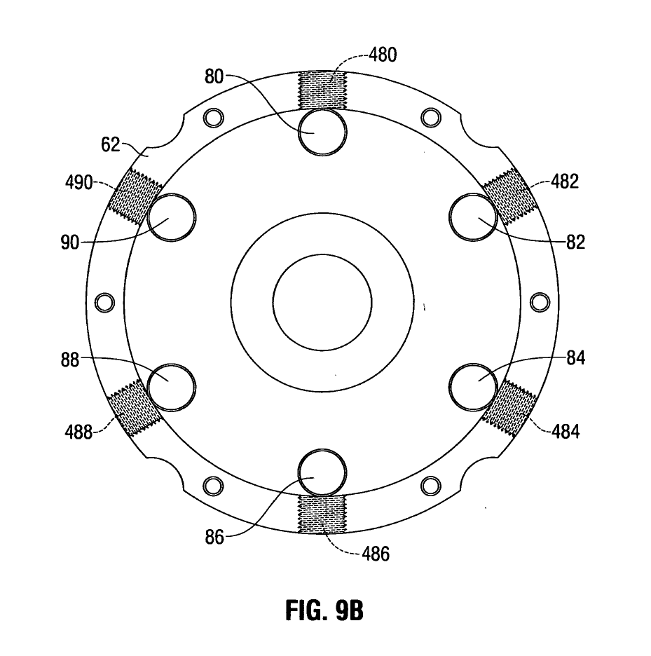

FIG. 9A is a pictorial view of an electronic probe sub-housing 60 having a cylindrical wall 62, a top cover plate 64 and a central, raised portion 66 having an opening 67 partially there-thru to accept the end 40 of the drive shaft 32. The top cover plate 64 of the sub-housing 60 has six (6) holes, 80, 82, 84, 86, 88 and 90 there thru for the insertion of one or more magnetic pickup probes, preferable the two probes 72 and 79.

FIGS. 2, 3, 9A and 9B illustrate a plurality of side holes 480, 482, 484, 486, 488 and 490 through the side wall 62. The side holes are aligned to provide access to the probes (72, 79) inserted through one or more of the holes 80, 82, 84, 86, 88 and 90, thus providing a method for calibrating the air gap between the probe (72, 79) and the extensions 52 in FIG. 8A. For example, side hole 480 aligned with the hole 80, etc.

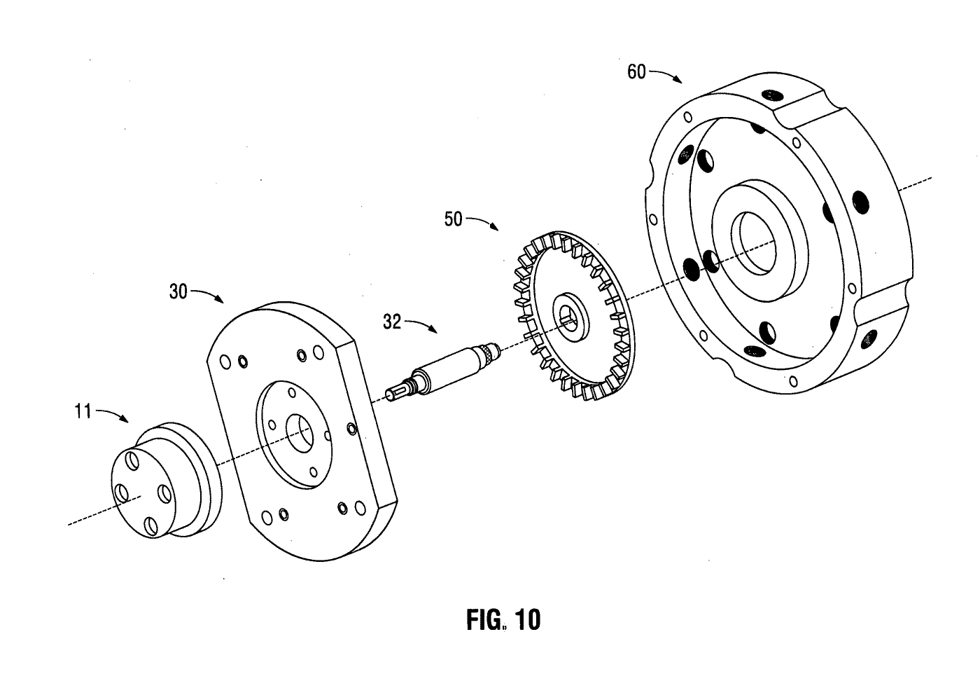

In the assembly of the components illustrated in FIG. 10, the end cap 11 is first threadely attached through the use of threaded bolts through the mounting holes 12, 14, 16 and 18, and the mating holes 20, 22, 24 and 26, respectively. Alternatively, the cap 11 and plate 30 can be cast, milled or otherwise formed as a single component from a castable or millable material, for example, cast iron. The end 36 of draft shaft 32 is inserted within the thru-holes 28 and 34, and then through the thru-hole 56, until the key on the exterior surface of shaft 32 is seated within the key seat 58. With this assembly, the end 40 of the shaft 32 is rotatably seated in the receptacle 67.

Although not illustrated in FIG. 4A, one or more electronic probes (magnetic pickup devices) such as the two probes 72 and 79 can be inserted through two of the thru-holes 80, 82, 84, 86, 88 and 90 to be proximate to the rotating gear ring and its extended elements 52.

The surface 62 of the sub-housing 60 illustrated in FIG. 9A is then moved against the back plate 30, thus enabling the housing 60 and plate 30 to be threaded connected together, through the use of threaded bolts through the holes 100, 102, 104, 106, 108 and 110, and the holes 200, 202, 204, 206, 208 and 210 respectively.

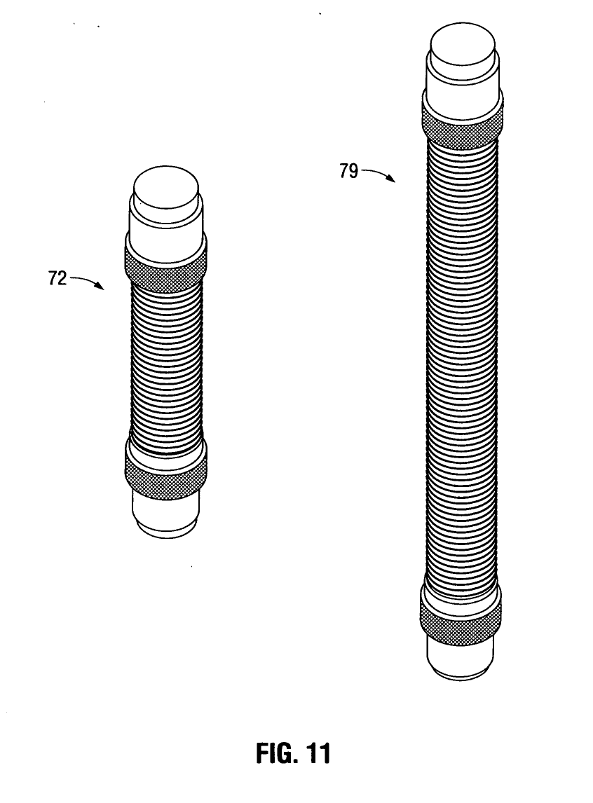

Referring now to FIG. 11, there is illustrated an exemplary magnetic probe (72, 79) which can be used in practicing the invention. The invention can be practiced through the use of a single such probe, as for example probe 72 or probe 79, but preferably as both probes 72 and 79 as discussed herein above with respect to FIG. 9. Operation. The gear ring 50 and its thirty extensions 52 are, in the preferred embodiment, fabricated from a ferrite material, for example, 4140 steel. However, the gear ring can be made, in a less preferable embodiment, from aluminum, for various reasons, including costs, ease of manufacture, weight and lack of oxidation. Aluminum is generally characterized as being non-magnetic. However, aluminum acts as if it is magnetic when subjected to a moving magnetic field. In 1833, Heinrich Emil Lenz formulated what is now known as “Lenz's Law”, which states that when a current is induced, it always flows in a direction that will oppose the change in magnetic field that causes it.

Be that as it may, the preferred embodiment of the invention calls for the gear ring and its extensions to be fabricated from a ferrite material, and more preferably, from 4140 steel. The other components of the electronic probe housing according to the invention are preferably fabricated from aluminum.

The magnetic pickup device can be purchased from many different sources, such as Daytronics Corporation, 2566 Kohnle Drive, Miamisburg, Ohio (USA) 45312, for example, their model no MP1A.

A magnetic pickup is essentially a coil wound around a permanently magnetized probe. When discrete ferromagnetic objects—such as gear teeth, turbine rotor blades, slotted discs, or shafts with keyways—are passed through the probe's magnetic field, the flux density is modulated. This induces AC voltages in the coil. One complete cycle of voltage is generated for each object passed.

If the objects are evenly spaced on a rotating shaft, the total number of cycles will be a measure of the total rotation, and the frequency of the AC voltage will be directly proportional to the rotational speed of the shaft.

(Output waveform is a function not only of rotational speed, but also of gear-tooth dimensions and spacing, pole-piece diameter, and the air gap between the pickup and the gear-tooth surface. The pole-piece diameter should be preferably less than or equal to both the gear width and the dimension of the tooth's top (flat) surface; the space between adjacent teeth should be approximately three times this diameter. Ideally, the air gap should be as small as possible, typically 0.005 inches. Thus, the devices 72 and 79 should be located, not quite touching, but very near to the extended elements 52 when the gear ring 50 is spinning.

Referring further to the embodiment of FIGS. 1B and 1C, the values to be used in the governor are first set, as is well known in this art. In the preferred embodiment, first assume that both magnetic sensors 72 and 79 are in place, one for measuring the RPM of the drive shaft causing the load to spin, and the other to generate electricity to operate the system, including the governor.

The governor preferably is set to allow some degree of speed change without adjusting the valve or valves, commonly referred to as “lead-lag” compensation. For example, the desired RPM may be set at 200 RPM, ±5 RPM. In this example, the valve or valves will not be changed so long as the RPM as determined by the probe 72 or 79, as the case may be, to be between 195 RPM and 205 RPM. Once the RPM is outside the range of 195-205 RPM for a given time interval, for example, for ten (10) seconds, then the valve or valves will be adjusted to bring the RPM to the desired range, as appropriate.

As an additional important feature of the present invention, the back plate 30 of FIG. 6A has the six (6) mounting holds 200, 202, 204, 206, 208 and 210 there-thru which allow the electronic probe housing in accordance with the invention to be used, without any significant modification, with all existing makes and models of commercially available steam turbines throughout the world.

There has thus been illustrated and described herein an electronic probe, according to the invention, housing which is easily mounted onto nearly every make and model of steam turbines, characterized by an inner chamber in the housing surrounding a first end of a drive shaft upon which the turbine blades are mounted, and being further characterized as having a gear ring within the inner chamber fixedly attached to the first end of the drive shaft. The gear ring has a plurality of spaced extensions, fabricated preferably from a ferrite material, and even more preferably from 4140 steel. At least one, preferably two magnetic pickup sensors are mounted at least partially, within the inner chamber of the housing in near proximity to the spaced extensions as the gear ring revolves with the drive shaft while the magnetic pickup device or devices remain stationary within the housing. During the operation of the steam turbine, the electronic probe housing automatically sends electric signal to an electronic governor which, with no human intervention, will cause the RPM of the steam turbine to increase, decrease or remain constant.

1. An electronic probe assembly for use with a steam turbine having a drive shaft having first and second ends and turbine blades mounted on said drive shaft, comprising:
A housing having an inner chamber sized and adapted to surround and enclose a first end of said drive shaft;
A gear ring within said inner chamber fixedly connected to said drive shaft, whereby said gear ring and its plurality of extensions rotates responsive to the rotation of said drive shaft; and
At least one stationary magnetic pickup sensor at least partially mounted within the interior chamber, in close proximity to said extensions as said drive shaft rotates, whereby said at least one magnetic pickup sensor generates electrical signals as an indicia of the speed of revolution of the drive shaft.

2. The assembly according to claim 1, wherein said gear ring and its extensions are fabricated from a ferrite material.

3. The assembly of claim 1 wherein the gear ring and its extensions are fabricated from aluminum.

4. The assembly according to claim 1 wherein the gear ring extensions are fabricated from a ferrite material.

5. The assembly according to claim 1, wherein said extensions are fabricated from aluminum and coated with a ferrite material.

6. The assembly according to claim 1, wherein said at least one magnetic sensor comprise two such magnetic pickup sensors, a first magnetic pickup sensor to help in determining the speed of revolution of the drive shaft, and a second magnetic pickup sensor to generate electricity as needed.

7. An electronic probe for use with a steam turbine, comprising:
a length of rotatable drive shaft having first and second ends;
a housing having an inner chamber sized and adapted to surround and enclose said first end of said length of drive shaft;
a gear ring having a plurality of extensions, said gear ring being fixedly attached to said length of drive shaft, whereby said gear ring rotates responsive to the rotation of the length of drive shaft;
at least one magnetic pickup sensor mounted, at least partially, in said chamber for detecting the rate of rotation of the gear ring.

8. The assembly according to claim 7, wherein said gear ring and its extensions are fabricated from a ferrite material.

9. The assembly of claim 7, wherein the gear ring and its extensions are fabricated from aluminum.

10. The assembly according to claim 7, wherein the gear ring extensions are fabricated from a ferrite material.

11. The assembly according to claim 7, wherein said extensions are fabricated from aluminum and coated with a ferrite material.

12. The assembly according to claim 7, wherein said at least one magnetic sensor comprises two such magnetic pickup sensors, a first magnetic pickup sensor to help in determining the speed of revolution of the drive shaft, and a second magnetic pickup sensor to generate electricity as needed.
